(19) United States
(12) Patent Application Publication
(10) Pub. No.: US 2010/0022791 A1
(43) Pub. Date: Jan. 28, 2010

(54) ORGANOMETALLIC COMPLEXES AS HYDROGEN STORAGE MATERIALS AND A METHOD OF PREPARING THE SAME

(75) Inventors: Jisoon Ihm, Seoul (KR); Hoonkyung Lee, Pyeongtaek-si (KR); Hyo Jin Jeon, Incheon (KR); Jong Sik Kim, Daejeon (KR); Dong Ok Kim, Seoul (KR); Hee bock Yoon, Daejeon (KR); Jeasung Park, Daejeon (KR); Seong-Geun Oh, Seoul (KR); Chul Oh, Seoul (KR)

Correspondence Address: CANTOR COLBURN, LLP, 20 Church Street, 22nd Floor, Hartford, CT, 06103, US

(73) Assignees: SEOUL NATIONAL UNIVERSITY INDUSTRY FOUNDATION, Seoul (KR); HANWHA CHEMICAL CORPORATION, Seoul (KR); INDUSTRY-UNIVERSITY COOPERATION FOUNDATION HANYANG UNIVERSITY, Seoul (KR)

(21) Appl. No.: 12/441,155

(22) PCT Filed: Sep. 12, 2007
(86) PCT No.: PCT/KR2007/004404

§ 371 Date: Jul. 17, 2009

(30) Foreign Application Priority Data
Sep. 13, 2006 (KR) 10-2006-0088322
Sep. 7, 2007 (KR) 10-2007-0090753
Sep. 7, 2007 (KR) 10-2007-0090755

(51) Int. Cl. C07F 7/28

(52) U.S. Cl. 556/51

(57) ABSTRACT

The present invention relates to an organic-transition metal complex which can safely and reversibly store hydrogen in a high capacity, and a process for preparing the same. In order to achieve the objects, the hydrogen storage material according to the invention comprises a complex generated by combination of an organic substance containing a hydroxyl (—OH) group(s) with a transition metal containing compound, which can more effectively store hydrogen with more than one transition metal being bonded per molecule. Examples of the organic substances containing hydroxyl (—OH) group(s) include alkyl derivatives such as ethylene glycol, trimethylene glycol and glycerol, and hydroxyl-containing aryl derivatives such as fluoroglucinol. As the transition metal, titanium (Ti), vanadium (V) and scandium (Sc), which can make Kubas binding, may be mentioned.

### TECHNICAL FIELD

The present invention relates to hydrogen storage material for storing hydrogen via adsorption, and a process for preparing the same. More specifically, it relates to hydrogen storage material which can be used under mild condition (for example, for storage at 25° C., 30 atm; for release at 100° C. under 2 atm) as compared to conventional storage material, and dramatically increase the storage amount, and a process for preparing the same. In addition, the invention relates to organic-transition metal complex as hydrogen storage material which enables a large capacity of hydrogen storage in a safe and reversible manner, and a process for preparing the same.

### BACKGROUND ART

Extensive studies have been performed to employ hydrogen as a clean energy source that does not exhaust carbonic acid gas. However, for practical use as a future energy source, required are three kinds of technical developments: production of hydrogen, storage of hydrogen, and hydrogen fuel cell which converts hydrogen energy to electric energy. Particularly, in order to convert various vehicles, which use gasoline or light-oil to those using hydrogen energy, absolutely required is a technique for storing hydrogen which stores a large amount of hydrogen in a safe and convenient manner and enables loading hydrogen on the vehicles.

A number of techniques have been developed as hydrogen storing means, but compression of hydrogen under high pressure (350 atm or 700 atm), or storing hydrogen in a liquid by chilling it at an extremely low temperature (below −253° C.) involves safety problem (such as danger of explosion). As alternative approaches which do not involve safety concern, studies for storing hydrogen by adsorbing it onto another solid material have been continued, and the conventional techniques are as follows:

First one is to utilize metal hydride. By injecting hydrogen into the metal, the metal and hydrogen are chemically bonded to store hydrogen as shown in FIG. 1(a). The process has been researched by a number of scholars for decades, and the disclosure by L. Schlapbach and A. Zuttel [Nature 414, 353, (2001)] with regard to the process lists up the substances including lithium borohydride (LiBH₄), which had been developed until that time. Due to strong chemical bond between the metal and hydrogen atom, however, a high temperature is needed to separate hydrogen for use, and if the process is repeated, the structure of the metal substance itself is altered to degenerate the hydrogen storage function.

Second one is to utilize metal-organic framework. For example it is to store hydrogen between minute apertures in a substance such as 1,4-benzene dicarboxylate zinc oxide [Zn₄O(BDC)₃, (BDC=1,4-benzenedicarboxylate)]. Regarding the process, the achievement of research and development by N. L. Rosi et al. is disclosed in [Science 300, 1127, (2003)]. However, this process gives insufficient maximum hydrogen storage amount, and involves several disadvantages as in the case of metal hydrides.

As the third, suggested was a process for adsorbing on a surface of material having nano-structure, using carbon nanotubes, carbon nanofibers or graphite nanofibers (GNFs). For example, as illustrated in FIG. 1(c), when Sc atoms are attached on fluorine, it is expected that a large number of hydrogen molecules are to be adsorbed thereon, as was reported by Y. Zhao [Physical Review Letters, 94, 155504, (2005)]. As illustrated in FIG. 1(d), when Ti atoms are attached on carbon nanotubes, it is also expected that a large number of hydrogen molecules are to be well adsorbed, as reported by T. Yildirim and S. Ciraci [Physical Review Letters, 94, 175501, (2005)]. Though the maximum amount of hydrogen storage of these processes is higher than that of conventional processes, it is still insufficient to be practically utilized in an automobile. The matter of securing and arranging fllerenes or carbon nanotubes has not be contemplated yet, so that consideration of practical use is too early at present. It is reported that 67.5% of hydrogen can be stored in graphite nanofibers [J. Phys. Chem. B, 102, 4253, (1998)]; and that 14˜20% of hydrogen can be stored by doping alkali metal on carbon nanotubes [Chen et al., Science 285, 91, (1999)]. However, the reproducibility has been suspected because of matter of water content and errors in experimental procedure, and the principle of storage is still under dispute.

Fourth one is to utilize polymer metal complex represented by [X(CF₃SO₃)₂L₂]ₙ (X is bivalent transition metal and L is an organic ligand), as is disclosed in Japanese Patent Laid-Open No. 2005-232033. According to the process, a substance such as copper di-4,4′-bipyridylbistrifluorocarbon sulfate {[Cu(CF₃SO₃)₂(bpy)₂]ₙ} was synthesized, and application examples of the complex to gas separation or a storage device were suggested, but practical utilization cannot be expected because of the adsorption property in high pressure range (several megapascals (MPa)).

Fifth one is disclosed in Japanese Patent Laid-Open No. 2004-275951 which is a process to store hydrogen wherein the surface of noble metal, carbon or polymer porous substance is coated to block oxygen to selectively transmit hydrogen, and metal particulates are filled into the porous substance to selectively transmit hydrogen. Transition metal salt such as crystalline nickel sulfate (NiSO₄) is dissoluted and it is impregnated in porous zeolite to measure the hydrogen storage amount. However, it showed 1% by weight level of adsorption in high pressure range of several megapascals (MPa), so that practical utilization cannot be expected.

Sixth one is disclosed in US Patent Publication No. 20070039473 wherein polymer which can adsorb hydrogen is contained in metal oxide to carry out hydrogenation-dehydrogenation. According to the process, aqueous sodium vanadate (NaVO₃) solution is used to produce vanadium oxide (V₂O₅) powder via sol-gel displacement. Polymerization is carried out via reaction with aniline, and doping is performed by using a substance such as nickel. But the product shows adsorption under high pressure of 1000 psi or more, so that practical utilization cannot be considered.

Seventh one is to store hydrogen by employing hydrogenation-dehydrogenation using a transition metal catalyst on an expanded π-conjugated substrate, as described in U.S. Pat. No. 71,015,330 and Korean Patent Laid-Open No. 2006-0022651. An aromatic compound such as coronene is mixed with a transition metal compound such as titanium dihydride (TiH₂), and the mixture is subjected to milling under high temperature (200° C.) and high pressure (82 bar) to carry out hydrogenation, and then milling under high temperature (150° C.) and low pressure (1 bar) to carry out dehydrogenation, thereby hydrogen bond is chemically formed and broken. This process requires relatively severe condition of ball milling at 200° C. for 2 hours for hydrogenation, and ball milling at 150° C. for 7 hours for dehydrogenation. Since it suggests that resonance of methylenic hydrogen occurs as a result of ¹H NMR due to hydrogenation of coronene, the reaction time is too long with chemical bonding of hydrogen to π-conjugated system, so that practical utilization is difficult.

### DISCLOSURE

### [Technical Problem]

The object of the present invention is to provide an organic-transition metal hydride complex which is a safe hydrogen storage material and enables high capacity of hydrogen storage in a reversible manner.

Another object of the present invention is to provide a process for preparing said organic-transition metal hydride complex in a stable manner with good yield.

Still another object of the present invention is to provide an organic-transition metal halide complex, as a precursor for said organic-transition metal hydride complex, and a process for preparing the same.

Further, another object of the present invention is to provide hydrogen storage material comprising said organic-transition metal hydride complex, and a hydrogen storage device comprising said hydrogen storage material.

### [Technical Solution]

The present invention is contrived to solve the above-mentioned problems, and pertains to an organometallic complex prepared from bonding of a hydroxyl-containing organic substance with a transition metal compound, and a process for preparing the same.

The organic-transition metal hydride complex according to the invention is represented by Chemical Formula (1):

A-(OMHₘ)ₙ

wherein, A represents an organic molecule, M is one or more metal atom(s) selected from transition metals having the valency of at least 2; m is an integer that equals to (valency of M−1), and n is an integer selected from 1 to 1000.

More specifically, the invention relates to an organic-transition metal hydride complex prepared by reacting a hydrogen source with an organic-transition metal compound obtained from reacting a hydroxyl-containing organic compound with a transition metal compound.

Further, the invention relates to a hydrogen storage material containing said organic-transition metal hydride complex, and a hydrogen storage device which comprises said hydrogen storage material.

Now, the invention is described in more detail. All technical or scientific terms used herein have the same meaning conventionally understood by a person having ordinary skill in the technical field to which the invention belongs, if not specified otherwise.

Repeated descriptions about the same technical constitution or effect as in conventional techniques are omitted for simplicity.

The organic-transition metal hydride complex according to the present invention has a structure represented by Chemical Formula (1):

A-(OMHₘ)ₙ [Chemical Formula 1]

wherein, A represents an organic molecule, M is one or more metal atom(s) selected from transition metals having the valency of at least 2; m is an integer that equals to (valency of M−1), and n is an integer selected from 1 to 1000.

More preferably, the organic-transition metal hydride complexes represented by Chemical Formula (1) comprise compounds represented by Chemical (2) or (3):

R-(OMHₘ)ₙ [Chemical Formula 2]

Ar-(OMHₘ)ₙ [Chemical Formula 3]

In Chemical Formula (2), R represents C2˜C20 linear or branched aliphatic alkyl, or C5˜C7 alicyclic alkyl, and R may contain unsaturated bond(s) in the carbon chain;

in Chemical Formula (3), Ar comprises one or more aromatic ring(s), more specifically it is selected from C6˜C20 aromatic rings or fused rings having aromatic ring(s), and the carbon atoms which constitutes the aromatic ring or fused ring may be substituted by heteroatom(s) selected from nitrogen, oxygen and sulfur;

in Chemical Formula (2) or (3), R or Ar may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN, wherein R¹ to R³ are independently selected from a C1˜C30 linear or branched alkyl groups, X¹ is a halogen atom and k represents an integer from 0 to 10; and

in the Chemical Formula (2) or (3), M represents one or more transition metal atoms(s) having the valency of at least 2, m is an integer that equals to (valency of M−1), and n is an integer selected from 1 to 10. Preferably, the valency of M is in the range from 2 to 7, and m is an interger from 1 to 6, accordingly.

More preferably, Ar of Chemical Formula (3) is selected from the aromatic rings or fused rings having the structure represented by one of the following formulas, and the aromatic rings or fused rings may be substituted by one or more substituent(s) selected from —NO₂, —NO, —NH₂, —R¹, —OR², —(CO)R³, —SO₂NH₂, —SO₂X¹, —SO₂Na, —(CH₂)ₖSH and CN as mentioned above.

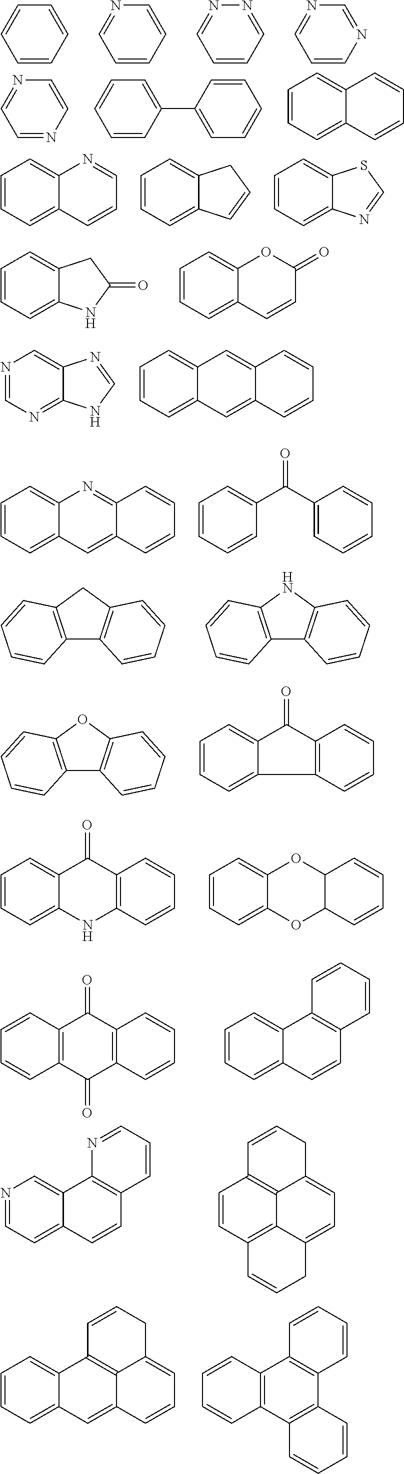

In Chemical Formulas (1) to (3), M is one or more atom(s) selected from elements having the valency of at least 2, and same or different kinds of metal element(s) may be contained in one compound. One or more element(s) selected from Ti, V and Sc is(are) more preferable to be used as hydrogen storage material since they can adsorb hydrogen via Kubas binding. More preferably, m is from 2 to 4, most preferably m is 3. More preferably, n is from 2 to 6.

The present invention provides hydrogen storage material comprising the organic-transition metal hydride complex of Chemical Formula (1) or a mixture thereof. When hydrogen (H₂) is adsorbed, the material can be represented by Chemical Formula (14):

A-(OM(H₂)_{q}Hₘ)ₙ [Chemical Formula 14]

wherein, A, M, m and n are defined as above, and q is an integer from 1 to 10.

Further, the present invention provides a hydrogen storage device which comprises the organic-transition metal hydride complex or a mixture thereof as hydrogen storage material.

In addition, the present invention provides an organic-metal halide complex represented by Chemical Formula (4) as a precursor for the organometallic hydride complex for hydrogen storage:

A-(OMXₘ)ₙ [Chemical Formula 4]

wherein, A, M, m and n are defined as in Chemical Formula (1), and X is a halogen atom selected from F, Cl, Br and I.

The organometallic halide complexes represented by Chemical Formula (4) comprise compounds represented by Chemical Formulas (5) or (6):

R-(OMXₘ)ₙ [Chemical Formula 5]

Ar-(OMXₘ)ₙ [Chemical Formula 6]

In Chemical Formula (5), R represents C2˜C20 linear or branched aliphatic alkyl or C5˜C7 alicyclic alkyl, and R may contain unsaturated bond(s) in the carbon chain;

in Chemical Formula (6), Ar is selected from C6˜C20 aromatic rings or fused rings having aromatic ring(s), and the carbon atoms which constitutes the aromatic ring or fused ring may be substituted by heteroatom(s) selected from nitrogen, oxygen and sulfur;

in Chemical Formula (5) or (6), R or Ar may be substituted by one or more substituent(s) selected from the group consisting of halogen atom, —NO₂, —NO, —NH₂, —R¹, —OR², —(CO)R³, —SO₂NH₂, —SO₂X², —SO₂Na, —(CH₂)ₖSH and CN, wherein R¹ to R³ are independently selected from a C1˜C30 linear or branched alkyl group and C6˜C20 aromatic groups, X¹ is a halogen atom and k represents an integer from 0 to 10; and

in the Chemical Formula (5) or (6), M represents one or more transition metal atoms(s) having the valency of at least 2, m is an integer that equals to (valency of M−1), X is a halogen atom, and n is an integer selected from 1 to 10.

In Chemical Formula (5) or (6), M is one or more atom(s) selected from Ti, V and Sc; and, more preferably, m is 3 and n is from 2 to 6. In Chemical Formula (6), Ar is preferably selected from the structures represented by one of the following formulas:

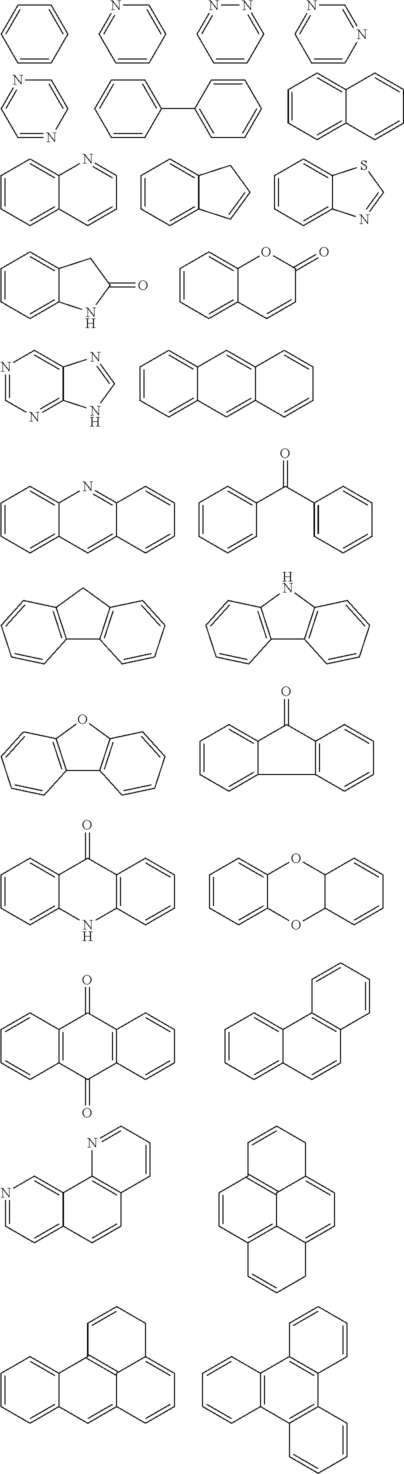

Further, the present invention provides a process for preparing an organic-transition metal halide complex represented by Chemical Formula (4), which comprises reacting a compound represented by Chemical Formula (7) having hydroxyl group(s) with a metal halide represented by Chemical Formula (10):

A-(OMXₘ)ₙ [Chemical Formula 4]

A-(OH)ₙ [Chemical Formula 7]

MXₘ₋₁ [Chemical Formula 10]

In Chemical Formula (4), (7) or (10), A, M, m and n are defined as in Chemical Formula (1), X represents a halogen atom selected from F, Cl, Br and I.

From one aspect of the process for preparing an organic-transition metal halide complex according to the present invention, the compound of Chemical Formula (4) is selected from the compounds represented by Chemical Formula (5), and the compound of Chemical Formula (7) is selected from the compounds represented by Chemical Formula (8):

R—(OMXₘ)ₙ [Chemical Formula 5]

R—(OH)ₙ [Chemical Formula 8]

In the Chemical Formula (5) or (8), R represents C2˜C20 linear or branched aliphatic alkyl or C5˜C7 alicyclic alkyl; R may contain unsaturated bond(s) in the carbon chain; and R may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN, wherein R¹ to R³ are independently selected from a C1˜C30 linear or branched alkyl group and C6˜C20 aromatic groups, X¹ is a halogen atom and k represents an integer from 0 to 10; M represents one or more transition metal atoms(s) having the valency of at least 2; X is a halogen atom; m is an integer that equals to (valency of M−1), and n is an integer selected from 1 to 10.

The compound represented by Chemical Formula (8) is selected from the group consisting of ethyleneglycol, trimethyleneglycol, glycerol, 1,2-propanediol, 1,4-butanediol, 1,2-hexanediol, 1,3-hexanediol, 2-ethyl-1,3-hexanediol, 3-chloro-1,2-propanediol, 1-butene-1,4-diol, 1,2-octanediol, 7-octene-1,2-diol, 1,2-cyclohexanediol, 1,3-cyclohexanediol, 1,2-cyclopentanediol, 1,3-cyclopentanediol, 4,4′-bicyclohexyldiol, 1,2-dodecanediol, 1,2-hexadecanediol, 1,16-hexadecanediol, 1,2,4-butanetriol, 1,3,5-pentanetriol, 1,3,5-cyclohexanetriol, 1,2,3-hexanetriol, 1,2,6-hexanetriol, 1,2,3-heptanetriol and 1,2,3-octanetriol, but not restricted thereto.

From another aspect of the process for preparing the organic-transition metal halide complex according to the present invention, the compound of Chemical Formula (4) is selected from the compounds represented by Chemical Formula (6), and the compound of Chemical Formula (7) is selected from the compounds represented by Chemical Formula (9):

Ar-(OMXₘ)ₙ [Formula 6]

Ar—(OH)ₙ [Formula 9]

In the Chemical Formula (6) or (9), Ar is selected from C6˜C20 aromatic rings or fused rings having aromatic ring(s), and the carbon atoms which constitutes the aromatic ring or the fused ring may be substituted by heteroatom(s) selected from nitrogen, oxygen and sulfur; the aromatic ring or the fused ring may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN (wherein R¹ to R³ are independently selected from a C1˜C30 linear or branched alkyl group and C6˜C20 aromatic groups, X¹ is a halogen atom and k represents an integer from 0 to 10); M represents one or more transition metal atoms(s) having the valency of at least 2; m is an integer that equals to (valency of M−1), and n is an integer from 1 to 10.

In Chemical Formula (6) or (9), Ar is selected from the aromatic rings or aromatic fused rings represented by one of the following formulas:

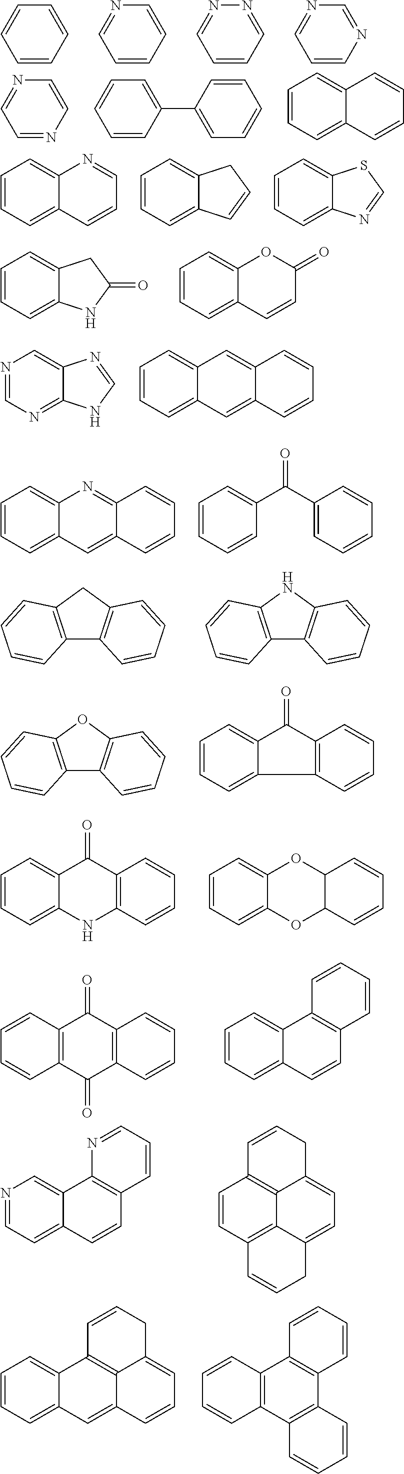

As the compound of Chemical Formula (9), a compound having the aromatic ring or the aromatic fused ring having a hydroxyl substituent may be also used, including hydroquinone and fluoroglucinol, specifically.

A process for preparing the organometallic halide complex according to the invention can be represented by following reaction formula:

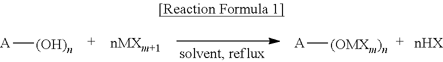

A hydroxyl-containing compound of Chemical Formula (7) and a compound of Chemical Formula (10) are separately dissolved in solvent, and the solution of compound (7) is added to the solution of compound (10) to obtain the organic-transition metal halide complex of Chemical Formula (4). Tetrahydrofuran, toluene, benzene, dichloromethane, chloroform, or the like can be used as the solvent. By controlling the injection rate of the organic substance of Chemical Formula (7), side reactions producing dimer, trimer or the like can be prevented. Since the metal halide of Chemical Formula (10) is apt to sensitively react with air or moisture to be converted to a stable metal oxide form, it is desirable that all procedures of synthesis and purification are carried out under nitrogen atmosphere and the organic solvent should be used after appropriate purification. The reaction temperature is from 60 to 120° C., more preferably from 80 to 100° C. The reaction is finished depending upon whether the generation of hydrohalide (HX) gas occurs or not. The reaction time is from 3 to 24 hours, more preferably from 10 to 20 hours. Then, the reaction mixture is worked-up with appropriate organic solvent in order to remove the unreacted substances and by-products. The organic solvent is then eliminated by using a rotary evaporator or distillation under reduced pressure. Drying in vacuo for at least one hour, more preferably for at least 5 hours gives organic-transition metal halide complex.

In addition, the invention provides a process for preparing an organic-transition metal hydride complex wherein the organic-transition metal hydride complex of Chemical Formula (1) is prepared by substitution reaction of the ligand (L) of the organic-transition metal complex of Chemical Formula (11) by hydrogen (H) in the presence of hydrogen source, which can be expressed by Reaction Formula (2):

A-(OMLₚ)ₙ [Chemical Formula 11]

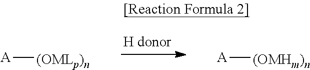

In Chemical Formula (11) or Reaction Formula (2), A, M, m and n are defined as above, and L is a leaving group which is not restricted as long as it can be released by substitution by hydrogen (H). Examples of L include halogen atom (X), —OR⁴, —NHR⁵, —SO₄, —NO₃, and the like, wherein R⁴ and R⁵ are independently selected from C1˜C10 linear or branched alkyl group. Value p is determined by (valency of M−1)/(valency of L)]. The valency of L means the number of bondings which can be bonded to the metal. Valency of L of halogen atom (X), —OR⁴, —NHR⁵ and —NO₃ is 1, while that of SO₄⁻² is 2. If the valency of M is in the range of 2˜7 and the valency of L is 1, p is an integer from 1 to 6, but if the valency is 2, p has a value of 0.5, 1, 1.5, 2, 2.5 or 3. For example, if M is tetravalent Ti ion and L is divalent SO₄²⁻ anion, the compound having q=4 is A-O₄Ti₄(SO₄)₆, that is A-(OTi(SO₄)_{1.5})₄ when expressed in the format of Chemical Formula (6).

The compounds of Chemical Formula (11) include the compounds represented by Chemical Formula (12) or (13):

R-(OMLₒ)ₙ [Chemical Formula 12]

(In the Formula, R, M and n are defined as in Chemical Formula (5), and L and p are defined as in Chemical Formula (11).)

Ar-(OMLₚ)ₙ [Chemical Formula 13]

(In the Formula, Ar, M and n are defined as in Chemical Formula (6), and L and p are defined as in Chemical Formula (11).)

The compound of Chemical Formula (11) can be prepared by reaction of a metal compound selected from metal alkoxides, metal alkylamido compounds, metal nitrates, metal sulfates and metal halides with a hydroxyl compound (A-(OH)ₙ). Preferably, L is a halogen atom (X). When L is a halogen atom, the organic-transition metal complex of Chemical Formula (6) can be represented by the organic-transition metal halide complex of Chemical Formula (4).

Now the process for preparing an organic-transition metal hydride complex is described by referring to an organic-transition metal halide complex of Chemical Formula (4) wherein L is a halogen atom, as an example, among the organic-transition metal complexes of Chemical Formula (11).

As a synthetic process for substituting a halide of an organic-transition metal halide complex with a hydride, a reaction of hydrodehalogenation using a hydrogen source and a catalyst at the same time, or a radical hydrodehalogenation using radical reductant and radical initiator at the same time can be referred as an example. The synthetic process is not restricted to those referred, but any conventional synthetic processes for substituting a halogen atom (X) with hydrogen (H) can be employed.

First, the hydrodehalogenation reaction uses H₂ gas as the hydrogen source, and one or more hydrogen donor(s) selected from the group consisting of phosphites such as sodium hypophosphate (NaH₂PO₂), sodium phosphite (NaH₂PO₃), sodium phosphate (NaH₂PO₄) or sodium perphosphate (NaHPO₅); metal hydrides such as lithium borohydride (LiBH₄), lithium aluminum hydride (LiAlH₄), sodium borohydride (NaBH₄), sodium aluminum hydride (NaAlH₄), magnesium borohydride (Mg(BH₄)₂), magnesium aluminum hydride (Mg(AlH₄)₂), calcium borohydride (Ca(BH₄)₂), calcium aluminum hydride (Ca(AlH₄)₂), lithium hydride (LiH), sodium hydride (NaH), potassium hydride (KH), magnesium hydride (MgH₂) and calcium hydride (CaH₂); formic acid, organic salts such as hydrazine hydrochloride, and C3˜C10 2-hydroxy alkane. More preferably, the organic-transition metal hydride complex can be prepared in high yield by carrying out hydrodehalogenation in liquid phase in the presence of a neutralizer selected from one or more hydroxide compounds such as NaOH and KOH, and a noble metal catalyst for 1˜12 hours.

In order to overcome the problem of conversion of the organic-transition metal halide complex as the reactant to a stabilized metal oxide form upon exposure to air or moisture, the amount of hydrogen supply during the reaction is maximized in the reaction mixture by supplying H₂ gas and the hydrogen donor at the same time. It is preferable to simultaneously select one or more hydrogen donor(s) from 1) α-hydrogen containing 2-hydroxy alkane having the property that it is relatively easy to be handled at ambient temperature and relatively easy to be released by methyl group (which serves as a leaving group adjacent to α-carbon), and 2) metal hydrides generating a large amount of hydrogen via hydrolysis with the action of noble catalyst under strongly basic condition. As 2-hydroxy alkane, 2-propanol or 2-butanol is preferably used. As metal hydride, one or more substance(s) selected from lithium borohydride (LiBH₄), sodium borohydride (NaBH₄) and magnesium borohydride (Mg(BH₄)₂) is (are) preferably used, with sodium borohydride being most preferable.

More specifically, the hydrodehalogenation comprises following steps:

a) mixing an organic-transition metal halide complex; one or more compound(s) selected from lithium borohydride (LiBH₄), sodium borohydride (NaBH₄) and magnesium borohydride (Mg(BH₄)₂) as metal hydride; and 2-propanol or 2-butanol as 2-hydroxy alkane, under nitrogen to prepare a reaction mixture; and

b) introducing a noble metal catalyst to the reaction mixture and heating the resultant mixture under reflux with hydrogen gas feeding.

As the noble metal catalyst one or more metal(s) selected from Pt, Pd, Ru and Rh can be used. Palladium (Pd) having high activity in hydrodehalogenation, or platinum (Pt) having high activity in hydrolysis of sodium borohydride can be more preferably used. In order to facilitate applications to mass production processes and catalyst recovery, the noble metal catalyst is preferably applied as a heterogeneous catalyst, that is in a solid catalyst form carried on a support. The support can be selected from carbon substance such as graphite, silica, alumina and titania. The amount of the nobel metal catalyst carried is from 1 to 20% by weight, preferably from 1 to 10% by weight, more preferably from 1 to 5% by weight on the basis of total weight of the support and the noble metal catalyst. If the amount is less than 1% by weight, active sites are insufficient to fail to proceed with the reaction. If the amount is more than 20% by weight, problem of high cost occurs due to the use of high cost noble metal catalyst.

In step b), it is preferable to add hydroxide compound in order to inhibit unstable generation of hydrogen from the metal hydride, and as a neutralizer for HX produced during the reaction. The hydroxide compounds include NaOH, KOH, or the like.

For the hydrodehalogenation, the preparation condition was established on the basis of the production parameters such as the individual contents of organic-transition metal halide complex as the reactant, hydrogen donor, neutralizer, noble metal catalyst in the reaction mixture, and pressure of H₂ gas applied, for the purpose of stable production of the organic-transition metal hydride complex as hydrogen storage material.

The content of the organic-transition metal halide complex in the reaction mixture is from 0.0001 to 1M, preferably from 0.001 to 0.5M, more preferably from 0.01 to 0.1M. If the content in the reaction vessel is less than 0.0001M, thorough proceeding of hydrodechlorination may be difficult, while if it is more than 1M, the by-products can not be thoroughly washed during the washing stage of the product after the reaction.

The content of the metal hydride in the reaction mixture is from 0.0001 to 30M, preferably from 0.001 to 15M, more preferably from 0.01 to 3M. If the content in the reaction vessel is less than 0.0001M, thorough proceeding of hydrodechlorination may be difficult, while if it is more than 30M, the by-products can not be thoroughly washed during the washing stage of the product after the reaction.

The content of 2-hydroxy alkane in the reaction mixture is from 0.0001 to 30M, preferably from 0.001 to 10M, more preferably from 0.01 to 3M. If the content in the reaction vessel is less than 0.0001M, thorough proceeding of hydrodechlorination may be difficult, while if it is more than 30M, the by-products can not be thoroughly washed during the washing stage of the product after the reaction.

The content of the hydroxide compound in the reaction mixture is from 0.0001 to 18M, preferably from 0.001 to 6M, more preferably from 0.01 to 1.8M. If the content in the reaction vessel is less than 0.0001M, neutralization of HCl by-product does not properly occur so that poisoning of the catalyst becomes severe to cause the problem of difficulties in completion of hydrohalogenation. If the content is more than 18M, excessive production of Na results in salt formation, to cause the problems in separation thereof.

The content of the noble metal catalyst in the reaction mixture is from 0.01 to 50 mol %, preferably from 1 to 50 mol % on the basis of the amount of the organic-transition metal halide complex. If the content of the noble metal catalyst is less than 0.01 mol %, thorough proceeding of the reaction may be difficult, while if it is more than 50 mol %, better effect can be hardly obtained but provides disadvantages in terms of cost.

The pressure of hydrogen gas supply in step b) is from 1 to 30 bar, preferably from 1 to 20 bar, more preferably from 1 to 10 bar. If the pressure is less than 1 bar, the reaction rate may be lowered, while if it is more than 30 bar, decomposition of the reactant may occur.

The duration of reaction under reflux in step b) is from 1 to 48 hours, preferably from 1 to 24 hours, more preferably from 1 to 12 hours. If the reaction time is less than 1 hour, incomplete reaction may occur, while if it is more than 48 hours, decomposition of the reactant may occur.

Now, described is the radical hydrodehalogenation wherein radical reductant and radical initiator are used at the same time.

The radical hydrodehalogenation employs radical reductant as the hydrogen source. One or more radical reductant(s) can be selected from TMS₃CH, Bu₃SnH, Ph₃SnH and Me₃SnH. In the radical hydrodehalogenation, radical initiator such as AIBN and VAZO (1,1-azobis(cyclohexane carbonitrile)) is employed along with the radical reductant.

According to the radical hydrodehalogenation, a halide is radicalized and then substituted by hydride via reductant to provide organic-transition metal hydride complex. The radical hydrodehalogenation, likewise said hydrodehalogenation, is carried out under nitrogen atmosphere, and it is preferable to use solvent, if any, that was purified in an appropriate manner, in order to prevent side reaction of producing metal oxide. Solvent such as tetrahydrofuran, toluene, benzene, dichloromethane and chloroform can be used.

In addition, the present invention provides a process for preparing an organometallic hydride complex, which comprises the steps of

(i) reacting a compound represented by Chemical Formula (7) having hydroxyl group(s) with a transition metal halide represented by Chemical Formula (10) to obtain an organic-transition metal halide complex represented by Chemical Formula (4); and

(ii) preparing the organic-transition metal hydride complex from the organic-transition metal halide complex represented by Chemical Formula (4) in the presence of hydrogen source.

A-(OMHₘ)ₙ [Chemical Formula 1]

A-(OMXₘ)ₙ [Chemical Formula 4]

A-(OH)ₙ [Chemical Formula 7]

MXₘ₋₁ [Chemical Formula 10]

[In the Chemical Formula (1), (4), (7) or (10), A is selected from R or Ar, wherein R represents C2˜C20 linear or branched aliphatic alkyl or C5˜C7 alicyclic alkyl, R may contain unsaturated bond(s) in the carbon chain, and Ar is selected from C6˜C20 aromatic rings or fused rings having aromatic ring(s), and the carbon atoms which constitutes the aromatic ring or the fused ring may be substituted by heteroatom(s) selected from nitrogen, oxygen and sulfur; and R and Ar may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN (wherein R¹ to R³ are independently selected from a C1˜C30 linear or branched alkyl group and C6˜C20 aromatic groups, X¹ is a halogen atom and k represents an integer from 0 to 10); and

M represents one or more transition metal atoms(s) having the valency of at least 2; X is a halogen atom; m is an integer that equals to (valency of M−1); and n is an integer from 1 to 10.]

As a synthetic process for substituting a halide of an organic-transition metal halide complex with a hydride, in step (ii), a reaction of hydrodehalogenation using a hydrogen source and a catalyst at the same time, or a radical hydrodehalogenation using radical reductant and radical initiator at the same time can be referred as an example. The synthetic process is not restricted to those referred, but any conventional synthetic processes for substituting a halogen atom (X) with hydrogen (H) can be employed.

### DESCRIPTION OF DRAWINGS

FIGS. 1(a), 1(b), 1(c) and 1(d) show chemical structures of three types of hydrogen storage materials according to the conventional techniques.

FIG. 2 shows chemical structure of novel hydrogen storage material having titanium atom bonded to an organic trimethylene glycol molecule according to one embodiment of the present invention.

FIG. 3 shows the chemical structure wherein hydrogen molecules are bonded as much as possible to the novel hydrogen storage material having titanium atom bonded to an organic trimethylene glycol molecule according to one embodiment of the present invention.

FIG. 4 schematically shows hydrodehalogenation reaction.

FIG. 5 is ¹H-NMR spectrum of 1,4-bis(trichlorotitanium)phenoxide).

FIG. 6 is ³⁵Cl-NMR spectrum of 1,4-bis(trichlorotitanium)phenoxide).

FIG. 7 shows results of EDS analysis of 1,4-bis(trichlorotitanium)phenoxide).

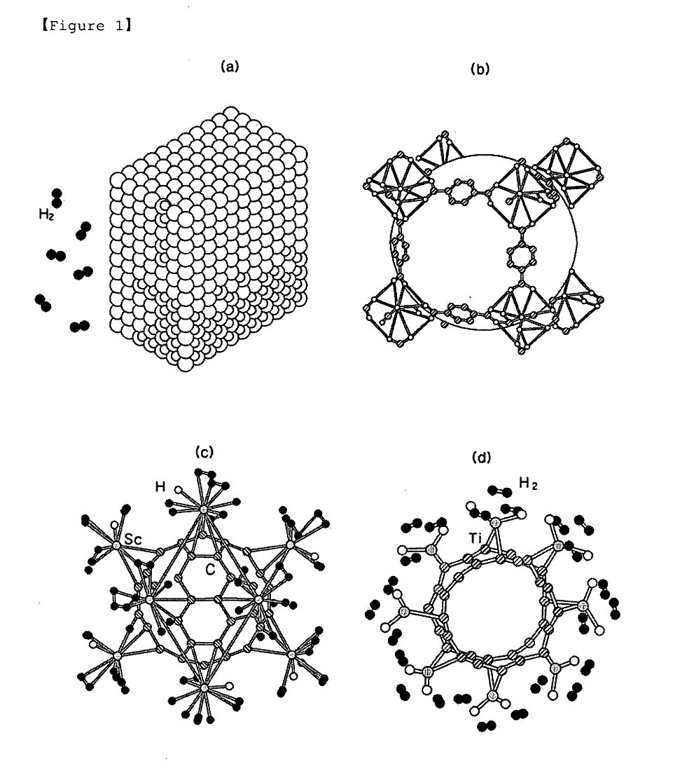

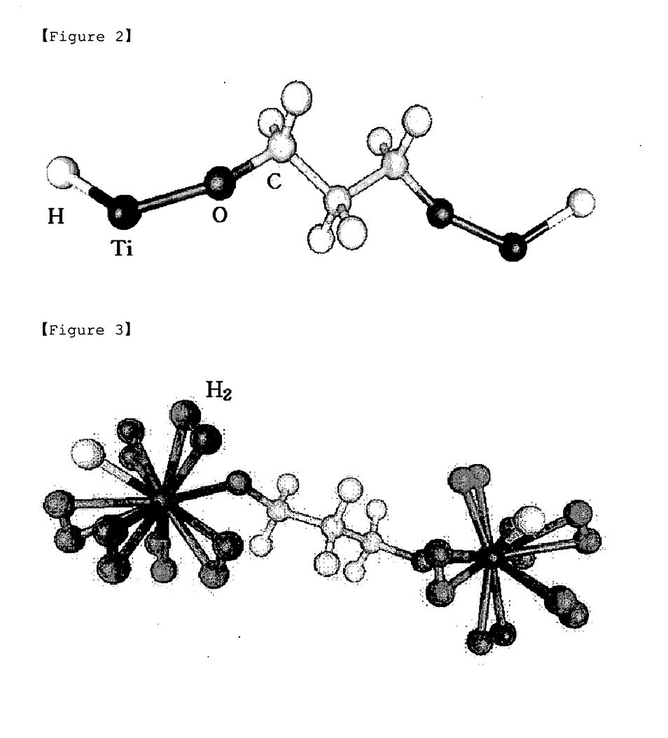

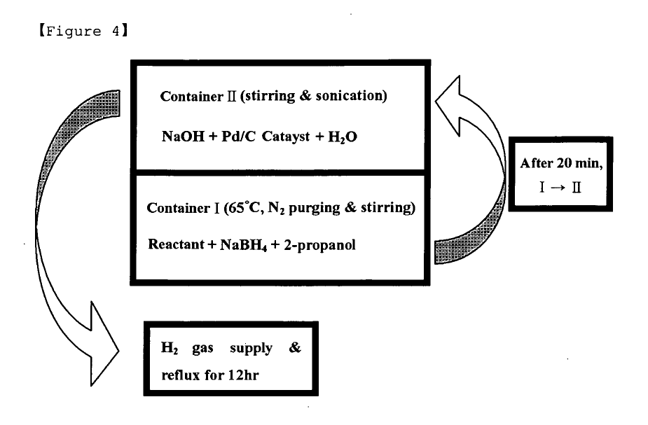

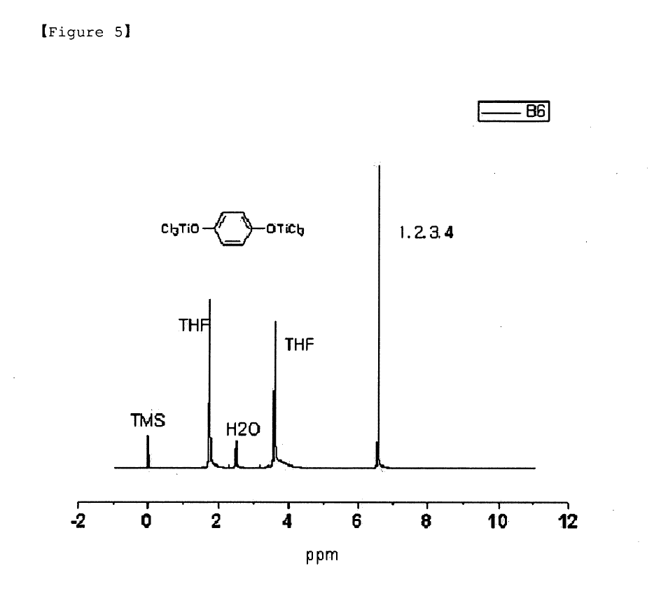

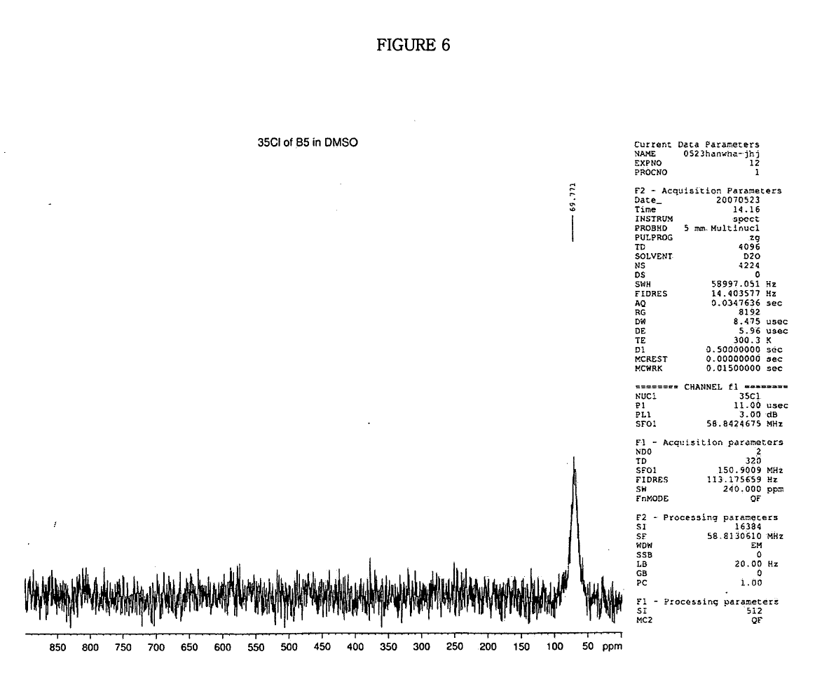

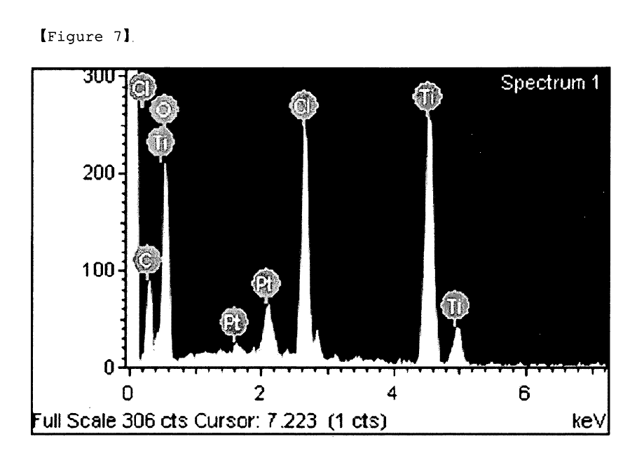

### MODE FOR INVENTION

Now the constitution and effect of one preferable embodiment of the present invention are described in detail by referring to the exemplified drawings. Such description is to enable a person having ordinary skill in the art to which the invention belongs to carry out the invention with ease, but not intends to restrict the scope of the invention.

### Example 1

### Preparation of bis(titanium (IV) hydride)propenoxide

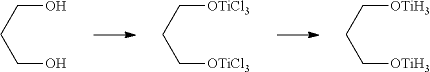

### (1) Preparation of bis(trichlorotitanium)propenoxide

To a 250 ml two-necked round-bottomed flask, charged were titanium (IV) chloride (2.9 ml, 0.026 mol) and toluene (40 ml) under nitrogen atmosphere. Trimethyleneglycol (0.988 g, 0.013 mol) thoroughly dissolved in tetrahydrofuran (30 ml) was slowly added thereto. The reaction mixture was heated at 90° C. under reflux for 24 hours to complete the reaction. After cooling to ambient temperature, the reaction mixture was filtered to remove the solvent, and washed with hexane (100 ml) and ethyl acetate (100 ml) to remove the residual reactants. Drying in vacuo gave 1,5-bis(trichlorotitanium)propenoxide in 95% of yield. Yield: 95% ¹H NMR(DMSO-d6) δ: 1.6 (bs, 2H), 3.4 (bs, 4H). ESI-MS (postitive mode), m/z (relative intensity): [C₃H₆(OTiCl₃)₂—H]+ 380.4 (9.9), 381.0 (9.4), 381.1 (100), 382.0 (23), 382.4 (10.1) Anal. Calc. for C₆H₃O₃Ti₃Cl₉: C, 9.47 H, 1.57. Found: C, 9.56 H, 1.6%.

### (2) Preparation of bis(titanium (IV) hydride)propenoxide

To a 100 ml three-necked round-bottomed flask, bis(trichlorotitanium)propenoxide thus obtained (0.06 g, 0.18 mmol) was charged under nitrogen atmosphere. Sodium borohydride (3 g) and 2-propanol (50 ml) were added thereto, and the resultant mixture was stirred at 65° C. for 12 hours. To another flask that had been separately prepared, palladium carried on carbon (Pd/C, Pd content: 5 wt %) (0.1 g) as a catalyst and aqueous sodium hydroxide solution (1M, 20 ml) were charged. After stirring for 20 minutes, the solution of bis(trichlorotitanium)propenoxide that had been previously prepared was slowly added, while hydrogen gas was injected under pressure of 5 bar. The reaction mixture was heated at 65° C. under reflux for 12 hours to complete the reaction.

After cooling to ambient temperature, the reaction mixture was filtered to remove the solvent, and distilled water (500 ml) was poured into the mixture. After extracting with dichloromethane (200 ml) three times, sodium sulfate (10 g) was added, and the mixture was stirred by using a rotary agitator for 30 minutes, and filtered. Dichloromethane was removed by using a rotary evaporator, and the residue was dried in vacuo to obtain bis(titanium (IV) hydride) propenoxide in 80% yield. Yield: 80% ESI-MS (positive mode), m/z (relative intensity): [C₃H₆(OTiH₃)₂—H]+ 173.5(9.9), 173.8(9.4), 174.3 (100), 175.0(10.1) Anal. Calc. for C₃H₁₂O₂Ti₂: C, 20.45 H, 6.81. Found: C, 20.5 H, 6.9%.

### Example 2

### Preparation of 1,2,3-tris(titanium (IV) hydride)propenoxide

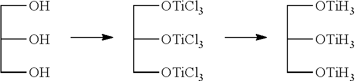

### (1) Preparation of 1,2,3-tris(trichlorotitanium)prepenoxide

In order to prepare 1,2,3-tris(trichlorotitanium)propenoxide, to a 250 ml two-necked round-bottomed flask, titanium (IV) chloride (2.9 ml, 0.026 mol) and toluene (40 ml) were added first. Then, glycerol (1,2,3-propanetriol) (1.196 g, 0.013 mol) thoroughly dissolved in tetrahydrofuran (30 ml) was slowly added thereto. The resultant mixture was heated at 90° C. under reflux for 24 hours to complete the reaction.

After cooling to ambient temperature, the reaction mixture was filtered to remove the solvent, washed with hexane (100 ml) and ethyl acetate (100 ml) to remove the residual reactant. Drying in vacuo gave 1,2,3-tris(trichlorotitanium)propenoxide in 90% yield. Yield: 90% ¹H NMR(DMSO-d6) δ: 3.5 (bs, 1H), 4.3 (bs, 4H). ESI-MS (positive mode), m/z (relative intensity): [C₃H₅ (OTiCl₃)₃—H]+ 547.5(9.9), 547.6 (9.4), 548.0(100), 548.2(23), Anal. Calc. for C₃H₅O₃Ti₃Cl₉: C, 6.56 H, 0.912. Found: C, 6.6H, 0.98%.

### (2) Preparation of 1,2,3-tris(titanium (IV) hydride)propenoxide

To a 100 ml three-necked round-bottomed flask, 1,4-bis(trichlorotitanium)phenoxide thus obtained (0.52 g, 0.95 mmol) was charged under nitrogen atmosphere. Toluene (50 ml), tristrimethyl silyl methane (TMS₃CH) (0.1 g, 1 mmol) and AIBN (0.05 g) were added thereto, and the mixture was stirred. The reaction mixture was heated at 100° C. under reflux for 24 hours, to complete the reaction.

After cooling to ambient temperature, the reaction mixture was filtered to remove the solvent, and distilled water (500 ml) was poured into the mixture. After extracting with dichloromethane (200 ml) three times, sodium sulfate (10 g) was added, and the mixture was stirred by using a rotary agitator for 30 minutes, and filtered. Dichloromethane was removed by using a rotary evaporator, and the residue was dried in vacuo to obtain 1,2,3-tris(titanium (IV) hydride)propenoxide in 70% yield. Yield: 85% ESI-MS (positive mode), m/z (relative intensity): [C₃H₅(OTiH₃)₃—H]+ 241.3(9.9), 241.5(9.4), 242.1 (100), 242.5(23), 242.7(10.1) Anal. Calc. for C₃H₅O₃Ti₃H₉: C, 14.8 H, 5.78. Found: C, 15.2 H, 5.99%.

### Example 3

### Preparation of bis(titanium (IV) hydride)ethoxide

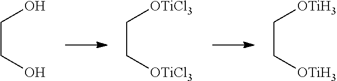

### (1) Preparation of bis(trichlorotitanium)ethoxide

In order to prepare bis(trichlorotitanium)ethoxide, to a 250 ml two-necked round-bottomed flask, titanium (IV) chloride (2.9 ml, 0.026 mol) and toluene (40 ml) were added. Then, ethyleneglycol (0.724 ml, 0.013 mol) thoroughly dissolved in tetrahydrofuran (30 ml) was slowly added thereto. The resultant mixture was heated at 90° C. under reflux for 24 hours to complete the reaction.

After cooling to ambient temperature, the reaction mixture was filtered to remove the solvent, washed with hexane (100 ml) and ethyl acetate (100 ml), and dried in vacuo to obtain bis (trichlorotitanium) ethoxide in 90% yield. Yield: 90% ¹H NMR(DMSO-d6) δ: 3.41 (bs, 4H). ESI-MS (positive mode), m/z (relative intensity): [C₂H₄(OTiCl₃)₂—H]+ 373.5(9.9), 373.7 (9.4), 374.5 (100), 374.9 (23), 375.8(10.1) Anal. Calc. for C₂H₄O₂Ti₂Cl₆: C, 6.5 H, 1.1. Found: C, 6.6H, 1.15%.

### (2) Preparation of bis(titanium (IV) hydride)ethoxide

To a 100 ml three-necked round-bottomed flask, bis(trichlorotitanium)ethoxide thus obtained (0.35 g, 0.95 mmol) was charged under nitrogen atmosphere. Toluene (50 ml), tristrimethylsilyl methane (TMS₃CH) (0.1 g, 1 mmol) and AIBN (0.05 g) were added thereto, and the mixture was stirred. The reaction mixture was heated at 100° C. under reflux for 24 hours, to complete the reaction.

After cooling to ambient temperature, the reaction mixture was filtered to remove the solvent, and distilled water (500 ml) was poured into the mixture. After extracting with dichloromethane (200 ml) three times, sodium sulfate (10 g) was added, and the mixture was stirred by using a rotary agitator for 30 minutes, and filtered. Dichloromethane was removed by using a rotary evaporator, and the residue was dried in vacuo to obtain bis (titanium (IV) hydride)ethoxide in 70% yield. Yield: 70% ESI-MS (positive mode), m/z (relative intensity): [C₂H₄(OTiH₃)₂—H]+ 373.5(9.9), 373.7(9.4), 374.5 (100), 374.9(23), 375.8(10.1) Anal. Calc. for C₂H₄0₂Ti₂H₆: C, 14.8 H, 6.17. Found: C, 15.1 H, 6.2%.

### Example 4

### Preparation of 1,3,5-tris(titanium (IV) hydride)phenoxide

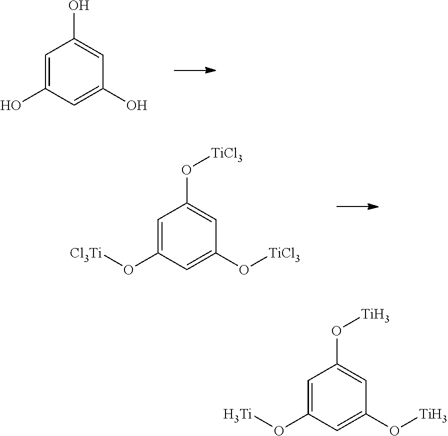

### (1) Preparation of 1,3,5-tris(trichlorotitanium)phenoxide

To a 250 ml two-necked round-bottomed flask, charged were titanium (IV) chloride (2.9 ml, 0.026 mol) and toluene (40 ml) under nitrogen atmosphere. Fluoroglucinol (1,3,5-trihydroxybenzene) (1.63 g, 0.013 mol) thoroughly dissolved in tetrahydrofuran (30 ml) was slowly added thereto. The reaction mixture was heated at 90° C. under reflux for 24 hours to complete the reaction.

After cooling to ambient temperature, the reaction mixture was filtered to remove the solvent, and washed with hexane (100 ml) and ethyl acetate (100 ml) to remove the residual reactants. Drying in vacuo gave 1,3,5-tris(trichlorotitanium)phenoxide in 95% of yield. Yield: 95% ¹H NMR(DMSO-d6) δ: 6.52 (bs, 3H). ESI-MS (postitive mode), m/z (relative intensity): [C₆H₃(OTiCl₃)₃—H]+ 571.3 (9.9), 572.0 (9.4), 572.3 (100), 572.4 (23), 573.1 (10.1) Anal. Calc. for C₆H₃O₃Ti₃Cl₉: C, 12.58; H, 0.52. Found: C, 12.35; H, 0.58%.

### (2) Preparation of 1,3,5-tris(titanium (IV) hydride)phenoxide

To a 100 ml three-necked round-bottomed flask, 1,3,5-tris(trichlorotitanium)phenoxide thus obtained (0.22 g, 0.18 mmol) was charged under nitrogen atmosphere. Sodium borohydride (3 g) and 2-propanol (50 ml) were added thereto, and the resultant mixture was stirred at 65° C. for 12 hours. To another flask that had been separately prepared, palladium carried on carbon (Pd/C, Pd content: 5 wt %) (0.1 g) and aqueous sodium hydroxide solution (1M, 20 ml) were charged. After stirring for 20 minutes, the solution of tris(trichlorotitanium)phenoxide that had been previously prepared was slowly added, while hydrogen gas was injected under pressure of 5 bar. The reaction mixture was heated at 65° C. under reflux to complete the reaction.

After cooling to ambient temperature, the reaction mixture was filtered to remove the solvent, and distilled water (500 ml) was poured into the mixture. After extracting with dichloromethane (200 ml) three times, sodium sulfate (10 g) was added, and the mixture was stirred by using a rotary agitator for 30 minutes, and filtered. Dichloromethane was removed by using a rotary evaporator, and the residue was dried in vacuo to obtain 1,3,5-tris(titanium (IV) hydride) phenoxide in 80% yield. Yield: 80% ESI-MS (positive mode), m/z(relative intensity): [C₆H₃(OTiH₃)₃—H]+ 275.8(9.9), 275.9 (9.4), 276.1(100), 276.6 (23), 276.8 (10.1) Anal. Calc. for C₆H₃O₃Ti₃H₉: C, 26.08; H, 4.34. Found: C, 26.3; H, 4.5%.

### Example 5

### Preparation of 1,4-bis(titanium (IV) hydride)phenoxide

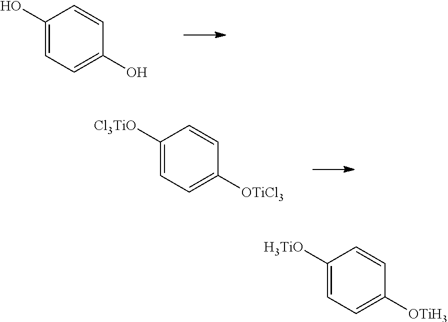

### (1) Preparation of 1,4-bis(trichlorotitanium)phenoxide

In order to prepare 1,4-bis(trichlorotitanium)phenoxide, titanium (IV) chloride (2.9 ml, 0.026 mol) and toluene (40 ml) were firstly charged to a 250 ml two-necked round-bottomed flask under nitrogen atmosphere. Hydroquinone (1,4-hydroxy benzene) (1.5 g, 0.013 mol) thoroughly dissolved in tetrahydrofuran (30 ml) was slowly added thereto. The reaction mixture was heated at 90° C. under reflux for 24 hours to complete the reaction.

After cooling to ambient temperature, the reaction mixture was filtered to remove the solvent, and washed with hexane (100 ml) and ethyl acetate (100 ml) to remove the residual reactants. Drying in vacuo gave 1,4-bis(trichlorotitanium)phenoxide in 90% of yield. Yield: 90% ¹H NMR (DMSO-d₆) d: 6.48 (bs, 4H). ESI-MS (positive mode), m/z(relative intensity): [C₆H₄(OTiCl₃)₂—H]+ 415.2(9.9), 415.3 (9.4), 415.5 (100), 416.1 (23), 416.3 (10.1) Anal. Calc. for C₆H₄O₂Ti₂Cl₆: C, 17.3; H, 0.96. Found: C, 17.35; H, 0.99%.

### (2) Preparation of 1,4-bis(titanium (IV) hydride)phenoxide

To a 100 ml three-necked round-bottomed flask, 1,4-bis(trichlorotitanium)phenoxide thus obtained (0.074 g, 0.18 mmol) was charged under nitrogen atmosphere. Sodium borohydride (3 g) and 2-propanol (50 ml) were added thereto, and the resultant mixture was stirred at 65° C. for 12 hours. To another flask that had been separately prepared, palladium carried on carbon (Pd/C, Pd content: 5 wt %) (0.1 g) and aqueous sodium hydroxide solution (1M, 20 ml) were charged. After stirring for 20 minutes, the solution of bis(trichlorotitanium)phenoxide that had been previously prepared was slowly added, while hydrogen gas was injected under pressure of 5 bar. The reaction mixture was heated at 65° C. under reflux to complete the reaction.

After cooling to ambient temperature, the reaction mixture was filtered to remove the solvent, and distilled water (500 ml) was poured into the mixture. After extracting with dichloromethane (200 ml) three times, sodium sulfate (10 g) was added, and the mixture was stirred by using a rotary agitator for 30 minutes, and filtered. Dichloromethane was removed by using a rotary evaporator, and the residue was dried in vacuo to obtain 1,4-bis(titanium (IV) hydride)phenoxide in 83% yield. Yield: 83% ESI-MS (positive mode), m/z(relative intensity): [C₆H₄(OTiH₃)₂—H]+ 209.7(9.9), 209.9(9.4), 210.2(100), 210.8(23), 211.5(10.1) Anal. Calc. for C₆H₄O₂Ti₂H₆: C, 34.4; H, 4.76. Found: C, 35.0; H, 4.8% .

### Example 6

### Preparation of titanium (IV) hydride phenoxide

### (1) Preparation of trichlorotitanium phenoxide

In order to prepare trichlorotitanium phenoxide, to a 250 ml two-necked round-bottomed flask, titanium (IV) chloride (2.9 ml, 0.026 mol) and toluene (40 ml) were added first under nitrogen atmosphere. Then, phenol (hydroxy benzene) (1.22 g, 0.013 mol) thoroughly dissolved in toluene (30 ml) was slowly added thereto. The resultant mixture was heated at 90° C. under reflux for 24 hours to complete the reaction.

After cooling to ambient temperature, the reaction mixture was filtered to remove the solvent, washed with hexane (100 ml) and ethyl acetate (100 ml), and dried in vacuo to obtain trichlorotitanium phenoxide in 95% yield. Yield: 95% ¹H NMR(DMSO-d₆) d: 6.8 (ds,2H) 6.84 (ds, 1H), 7.24 (ds, 2H). ESI-MS (positive mode), m/z(relative intensity): [C₆H₄(OTiCl₃)₂—H]+ 245.86(9.9), 245.89 (9.4), 245.9 (100), 246.23 (23), 246.5 (10.1) Anal. Calc. for C₆H₄O₂Ti₂Cl₆: C, 29.14; H, 2.04. Found: C, 29.5; H, 2.1%.

### (2) Preparation of titanium (IV) hydride phenoxide

To a 100 ml three-necked round-bottomed flask, trichlorotitanium phenoxide (0.23 g, 0.95 mmol) thus obtained was charged under nitrogen atmosphere. Toluene (50 ml), tristrimethylsilyl methane (TMS₃CH) (0.1 g, 1 mmol) and AIBN (0.05 g) were added thereto, and the mixture was stirred. The reaction mixture was heated at 100° C. under reflux for 24 hours, to complete the reaction.

After cooling to ambient temperature, the reaction mixture was filtered to remove the solvent, and distilled water (500 ml) was poured into the mixture. After extracting with dichloromethane (200 ml) three times, sodium sulfate (10 g) was added, and the mixture was stirred by using a rotary agitator for 30 minutes, and filtered. Dichloromethane was removed by using a rotary evaporator, and the residue was dried in vacuo to obtain titanium (IV) hydride phenoxide in 70% yield. Yield: 70% ESI-MS (positive mode), m/z(relative intensity): [C₂H₄(OTiH₃)₂—H]+ 143.0(9.9), 143.11 (9.4), 143.5 (100), 143.6 (23) Anal. Calc. for C₆H₅OTiH₃: C, 50.34 H, 4.89 Found: C, 50.4 H, 4.9%.

### INDUSTRIAL APPLICABILITY

The organometallic hydride complex according to the invention as hydrogen storage material can store and use under a condition approximate to ambient temperature and ambient pressure via Kubas binding between transition metal and hydrogen. In addition, the complex can bind multiple transition metals per molecule since it utilize hydroxyl group as a reactive group, so that excellent weight percentage of stored hydrogen per total material suggested as hydrogen storage material, and weight of hydrogen per unit volume are expected.

The process for preparing organic-transition metal hydride according to the present invention provides an advantage of preparing the object substance, organic-transition metal hydride, under stable production condition in a good yield.

1. An organic-transition metal hydride complex represented by Chemical Formula (1), wherein a transition metal atom is bonded to an oxygen atom of an organic molecule containing a hydroxyl group (—OH).
A-(OMHₘ)ₙ [Chemical Formula 1]
[In the Formula, A represents an organic molecule, M is one or more metal atom(s) selected from transition metals having the valency of at least 2; m is an integer that equals to (valency of M−1), and n is an integer selected from 1 to 1000.]

2. An organic-transition metal hydride complex according to claim 1, wherein said organic-transition metal hydride complex is represented by one of the structures represented by Chemical Formula (2) or Chemical Formula (3):
R-(OMHₘ)ₙ [Chemical Formula 2]
Ar-(OMHₘ)ₙ [Chemical Formula 3]
[In Chemical Formula (2), R represents C2˜C20 linear or branched aliphatic alkyl, or C5˜C7 alicyclic alkyl, and R may contain unsaturated bond(s) in the carbon chain;
in Chemical Formula (3), Ar is selected from C6˜C20 aromatic rings or fused rings having aromatic ring(s), and the carbon atoms which constitutes the aromatic ring or fused ring may be substituted by heteroatom(s) selected from nitrogen, oxygen and sulfur;
in Chemical Formula (2) or (3), R or Ar may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN (wherein R¹ to R³ are independently selected from a C1˜C30 linear or branched alkyl group and C6˜C60 aromatic groups, X¹ is a halogen atom and k represents an integer from 0 to 10); and
in the Chemical Formula (2) or (3), M represents one or more transition metal atoms(s) having the valency of at least 2, m is an integer that equals to (valency of M−1), and n is an integer selected from 1 to 10.]

3. An organic-transition metal hydride complex according to claim 2, wherein M in Chemical Formula (2) or (3) is one or more atom(s) selected from Ti, V and Sc; m is 3; and n is from 2 to 6.

4. An organic-transition metal hydride complex according to claim 2, wherein Ar in Chemical Formula (3) is represented by one of the following formulas:

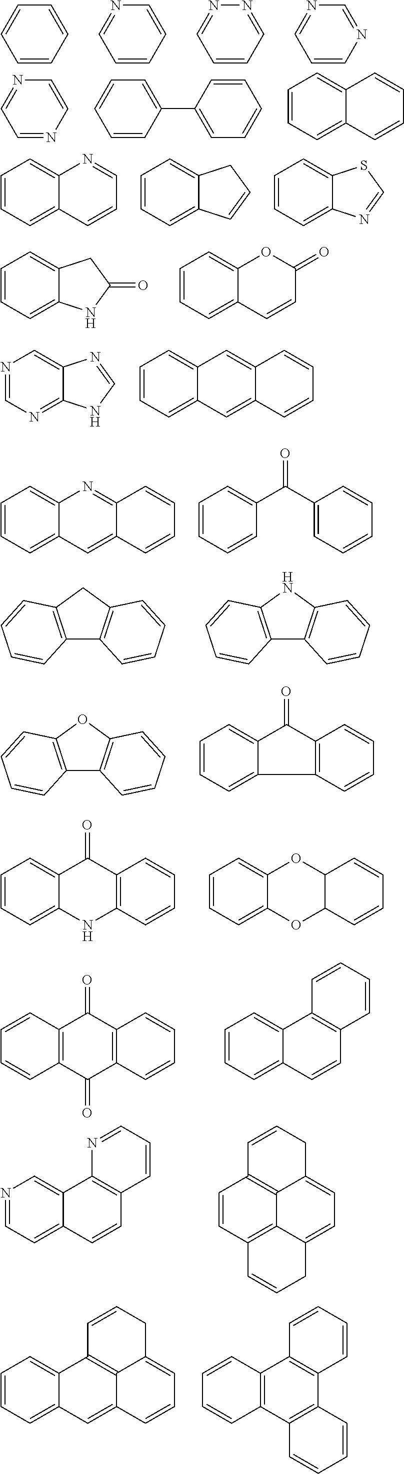

5. An organic-transition metal halide complex represented by Chemical Formula (5) or Chemical Formula (6):
R-(OMXₘ)ₙ [Chemical Formula 5]
Ar-(OMXₘ)ₙ [Chemical Formula 6]
[In Chemical Formula (5), R represents C2˜C20 linear or branched aliphatic alkyl or C5˜C7 alicyclic alkyl, and R may contain unsaturated bond(s) in the carbon chain;
in Chemical Formula (6), Ar is selected from C6˜C20 aromatic rings or fused rings having aromatic ring(s), and the carbon atoms which constitutes the aromatic ring or fused ring may be substituted by heteroatom(s) selected from nitrogen, oxygen and sulfur;
in Chemical Formula (5) or (6), R or Ar may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN (wherein R¹ to R³ are independently selected from a C1˜C30 linear or branched alkyl group and C6˜C20 aromatic groups, X¹ is a halogen atom and k represents an integer from 0 to 10); and
in the Chemical Formula (5) or (6), M represents one or more transition metal atoms(s) having the valency of at least 2, m is an integer that equals to (valency of M−1), X is a halogen atom, and n is an integer selected from 1 to 10.]

6. An organic-transition metal halide complex according to claim 5, wherein M in Chemical Formula (5) or (6) is one or more atom(s) selected from Ti, V and Sc; m is 3; and n is from 2 to 6.

7. An organic-transition metal halide complex according to claim 5, wherein Ar in Chemical Formula (6) is represented by one of the following formulas:

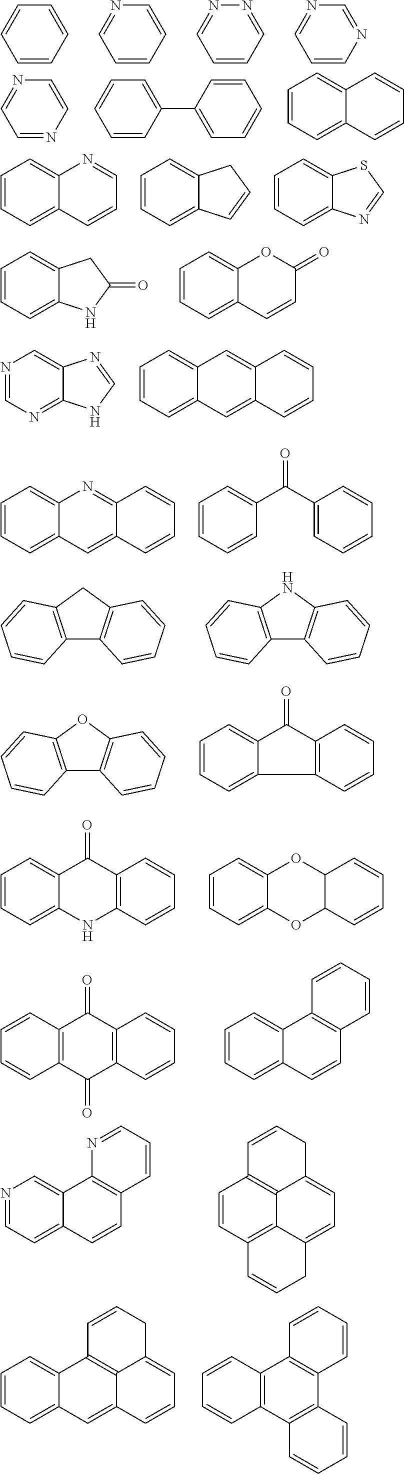

8. A process for preparing an organic-transition metal hydride complex, wherein the organic-transition metal hydride complex represented by Chemical Formula (1) is prepared from an organic-transition metal complex represented by Chemical Formula (11) in the presence of hydrogen source.
A-(OMHₘ)ₙ [Chemical Formula 1]
A-(OMLₚ)ₙ [Chemical Formula 11]
[In the formulas, A represents an organic molecule; M represents one or more transition metal atoms(s) having the valency of at least 2; m is an integer that equals to (valency of M−1); n is an integer from 1 to 1000; L is selected from the group consisting of a halogen atom (X), —OR⁴, —NHR⁵, —SO₄ and —NO₃ (R⁴ and R⁵ independently represent C1˜C10 linear or branched alkyl group); and p is a value determined by (valency of M−1)/(valency of L).]

9. A process for preparing an organic-transition metal hydride complex according to claim 8, wherein the compound of Chemical Formula (1) is selected from the compounds represented by Chemical Formula (2), and the compound of Chemical Formula (11) is selected from the compounds represented by Chemical Formula (12):
R-(OMHₘ)ₙ [Chemical Formula 2]
R-(OMLₚ)ₙ [Chemical Formula 12]
[In the Chemical Formula (2) or (12), R represents C2˜C20 linear or branched aliphatic alkyl or C5˜C7 alicyclic alkyl; R may contain unsaturated bond(s) in the carbon chain; R may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and —CN (wherein R¹ to R³ are independently selected from a C1˜C30 linear or branched alkyl group and C6˜C20 aromatic groups, X¹ is a halogen atom and k represents an integer from 0 to 10); M represents one or more transition metal atoms(s) having the valency of at least 2; m is an integer that equals to (valency of M−1); n is an integer selected from 1 to 10; L is selected from the group consisting of a halogen atom (X), —OR⁴, —NHR⁵, —SO₄ and —NO₃ (R⁴ and R⁵ independently represent C1˜C10 linear or branched alkyl group); and p is a value determined by (valency of M−1)/(valency of L).]

10. A process for preparing an organic-transition metal hydride complex according to claim 8, wherein the compound of Chemical Formula (1) is selected from the compounds represented by Chemical Formula (3), and the compound of Chemical Formula (11) is selected from the compounds represented by Chemical Formula (13):
Ar-(OMHₘ)ₙ [Chemical Formula 3]
Ar-(OMLₚ)ₙ [Chemical Formula 13]
[In the Chemical Formula (3) or (13), Ar is selected from C6˜C20 aromatic rings or fused rings having aromatic ring(s), and the carbon atoms which constitutes the aromatic ring or the fused ring may be substituted by heteroatom(s) selected from nitrogen, oxygen and sulfur; the aromatic ring or the fused ring may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN (wherein R¹ to R³ are independently selected from a C1˜C30 linear or branched alkyl group and C6˜C20 aromatic groups, X¹ is a halogen atom and k represents an integer from 0 to 10); M represents one or more transition metal atoms(s) having the valency of at least 2; m is an integer that equals to (valency of M−1); n is an integer from 1 to 10; L is selected from the group consisting of a halogen atom (X), —OR⁴, —NHR⁵, —SO₄ and —NO₃ (R⁴ and R⁵ independently represent C1˜C10 linear or branched alkyl group); and p is a value determined by (valency of M−1)/(valency of L)].

11. A process for preparing an organic-transition metal hydride complex according to claim 9, wherein the compound of Chemical Formula (12) is a compound represented by Chemical Formula (5):
R-(OMXₘ)ₙ [Chemical Formula 5]
wherein, R, M, m and n are defined as in claim 9, and X is a halogen atom selected from F, Cl, Br and I.

12. A process for preparing an organic-transition metal hydride complex according to claim 8, wherein hydrogen gas as the hydrogen source; and one or more substance(s) selected from the group consisting of phosphites such as sodium hypophosphate (NaH₂PO₂), sodium phosphite (NaH₂PO₃), sodium phosphate (NaH₂PO₄) or sodium perphosphate (NaHPO₅); metal hydrides such as lithium borohydride (LiBH₄), lithium aluminum hydride (LiAlH₄), sodium borohydride (NaBH₄), sodium aluminum hydride (NaAlH₄), magnesium borohydride (Mg(BH₄)₂), magnesium aluminum hydride (Mg(AlH₄)₂), calcium borohydride (Ca(BH₄)₂), calcium aluminum hydride (Ca(AlH₄)₂), lithium hydride (LiH), sodium hydride (NaH), potassium hydride (KH), magnesium hydride (MgH₂) and calcium hydride (CaH₂); formic acid, hydrazine hydrochloride and C3˜C10 2-hydroxy alkane are used.

13. A process for preparing an organic-transition metal hydride complex, which comprises the steps of
(i) reacting a compound represented by Chemical Formula (7) having hydroxyl group(s) with a transition metal halide represented by Chemical Formula (10) to obtain an organic-transition metal halide complex represented by Chemical Formula (4); and
(ii) preparing the organic-transition metal hydride complex of Chemical Formula (1) from the organic-transition metal halide complex represented by Chemical Formula (4) in the presence of hydrogen source.
A-(OMHₘ)n [Chemical Formula 1]
A-(OMXₘ)ₙ [Chemical Formula 4]
A-(OH)ₙ [Chemical Formula 7]
MXₘ₊₁ [Chemical Formula 10]
[In the Chemical Formula (1), (4), (7) or (10), A is selected from R or Ar, wherein R represents C2˜C20 linear or branched aliphatic alkyl or C5˜C7 alicyclic alkyl, R may contain unsaturated bond(s) in the carbon chain, and Ar is selected from C6˜C20 aromatic rings or fused rings having aromatic ring(s), and the carbon atoms which constitutes the aromatic ring or the fused ring may be substituted by heteroatom(s) selected from nitrogen, oxygen and sulfur; and R and Ar may be substituted by one or more substituent(s) selected from the group consisting of halogen atom, —NO₂, —NO, —NH₂, —R¹, —OR², —(CO)R³, —SO₂NH₂, —SO₂X¹, —SO₂Na, —(CH₂)ₖSH and CN (wherein R¹ to R³ are independently selected from a C1˜C30 linear or branched alkyl group and C6˜C20 aromatic groups, X¹ is a halogen atom and k represents an integer from 0 to 10); and
M represents one or more transition metal atoms(s) having the valency of at least 2; X is a halogen atom; m is an integer that equals to (valency of M−1); and n is an integer from 1 to 10.]

14. A hydrogen storage material which comprises the organic-transition metal hydride complex according to claim 1.

15. A hydrogen storage device which comprises the hydrogen storage material according to claim 14.
